(19) United States
(12) Patent Application Publication
(10) Pub. No.: US 2005/0226130 A1
(43) Pub. Date: Oct. 13, 2005

(54) Optical data storage

(75) Inventors: Emiel Peeters, Eindhoven (NL); Dirk Jan Broer, Eindhoven (NL); Christopher Busch, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/517,912

(22) PCT Filed: Jun. 12, 2003
(86) PCT No.: PCT/IB03/02737

§ 371 Date: Dec. 14, 2004

(30) Foreign Application Priority Data
Jun. 19, 2002 (EP) 02077425.3

(51) Int. Cl. G11B 7/00

(52) U.S. Cl. 369/125

(57) ABSTRACT

Optical data storage method, device and storage medium, comprising storing data by modifying optical properties of polymer material, whereby writing is initiated by reorientation of photoorientable units, typically by illuminating with light at a wave-length that initiates the reorientation.

The present invention relates to a method, device and storage medium for optical data storage.

There are a number of optical storage techniques. One example of a technique is based on changing reflectivity of a storage layer when “writing” thereto. This storage technique is typically not suitable for multi-layer recording in a stacked storage device because of ghost images, coherent cross talk as a result of coherent light, and poor transmission for each layer for both incident laser light and signal light. Yet another drawback is that a difference in index of refraction of written and non-written memory cells causes an optical beam to scatter as it transverses the different non-written layers, resulting in a decreased beam quality.

Another technique is to use fluorescent dyes that are dissolved in polymer matrices. In these cases the index of refraction can be tuned to that of the substrates to avoid problems with scattering of the optical beams. Furthermore, the multi-layer storage mediums can be chosen such that they are transparent at the fluorescent signals wavelengths, effectively eliminating half the losses and disturbances associated with standard reflective technologies.

By means of using fluorescent dyes, there are several possibilities to obtain a storage device. Irreversible storage of data such as Write Once Read Many (WORM) data storage is possible by photo bleaching of fluorescent material in a polymer matrix. The material is heated upon irradiation with a writing laser beam. Initially, quencher molecules are deposited in a layer above a layer containing the fluorescent material, comprising so-called “fluoro-phores”. When the material is heated by the laser beam the quencher molecules decompose and form radicals, which can diffuse to the fluoro-phores when the temperature exceeds the glass transition temperature of the polymer matrix and the melting and/or decomposition temperature of the quencher molecules. The chemical structure of the fluoro-phores, and hence the fluorescence spectrum and fluorescence efficiency is then changed when the fluoro-phores react with the radicals. The fluorescent signal emitted by reacted fluoro-phores is significantly different from the signal emitted by unreacted fluorophores when they are irradiated with a “reading beam”. This feature is then used for reading stored data. However, this concept suffers from the disadvantage of a low data rate during writing due to slow diffusion of the radicals. Furthermore, the contrast obtained is poor.

Another technique is to co-dissolve the quencher molecules with the fluoro-phores in the polymer matrix. In this way, the radicals, which are formed upon heating, do not have to diffuse into the layer containing the fluoro-phores and can directly attack them. This results in an increased data rate; however, a drawback is that the stability of the non-written memory cells is significantly decreased.

Another way of optically storing information is to irradiate a storage layer comprising polymers containing groups, which change their configuration upon exposure to light, so-called photo-chromic materials. There are many known photo-chromic materials such as spiropyran derivatives, polycyclic p-quinones, and fulgides. The photo-chromic materials generally show a fast response upon irradiation, facilitating high data transfer rates, typically much faster than the diffusion processes. However, for photo-chromic storage devices, there are several issues to be resolved before commercialisation is to be expected. For example, a serious issue is the (bi)stability of the photo-chromic materials. Although some photo-chromic materials exhibit a good thermal (bi)stability, the photo-stability is generally poor. Furthermore, the photo-chromic effects are linearly dependent upon the laser light intensity. Therefore, it is not trivial to store data in a multi-layer device without cross talk. Even if this problem can be circumvented by means of using photo-chromic effects based on two-photon absorption, these devices cannot be used with cheap diode lasers.

There is still a great demand for optical storage media, which have not only high recording densities, but also reversible storage of data. However, often data cannot be reversibly stored, or the construction of the storage device and the storing method are complex, or storing data is time consuming or temperature limited, which result in solutions that are not very useful in practice.

Thus, the problem of how to combine high stability of written and non-written storage areas with high writing speed and good sensitivity during writing still persists. Furthermore, problems including scattering, concerning stacking of storage layers to obtain large capacity have to be solved.

It is an object of the invention to provide a method for optically storing data providing high stability of stored information.

Another object of the invention is to provide a method for optically storing data at high speed. Herein, the term “high speed” means not significantly slower than within nano-seconds, such as within 10-50 ns.

According to an aspect of the invention, it has now been found that an especially beneficial form of optical data storage is provided by (re)orientation of anisotropic molecules initiated by a very short light pulse, which anisotropic molecules thereafter self-develop during a time period which is typically longer than the time period for the light pulse. Typically, this light is laser light.

Preferably, the variation of orientation (or molecular order) is achieved by means of irradiation of light, especially by means of a laser beam. Generally, the method is performed in such a manner that the optical information is stored by means of a laser beam through a local reorientation or disorientation of molecular segments.

According to another aspect of the invention, a device is provided for optical data storage using polymer material as storage medium, whereby the device comprises a film of polymer in order to store data by means of local variation of the molecular order, or orientation, of a polymer comprising photo-orientable groups.

According to a preferred embodiment of the invention, a method for writing data in a storage medium is provided, comprising polymer material by modifying its optical properties, said method comprising the steps of:
heating up the material above the glass-transition temperature (Tg), and
initiating the writing by reorientation of photo-orientable-groups in the polymer material by means of illuminating with light at a wavelength and for a time period, or other means, that initiates the reorientation.

According to another embodiment of the invention, a device is provided for optical data storage, comprising:
polymer material as storage medium,
means for heating up the material above the glass-transition temperature (Tg), and
means for initiating the writing by orientation of photo-orientable-units of the polymer by illuminating with light at a wave-length and for a time period, or other means, that initiates the reorientation, whereby data can be stored in the polymer material by modifying its optical properties.

According to yet another embodiment of the invention, a storage medium is provided comprising polymer material, adapted to store data by modifying its optical properties, said polymer material comprising photo-orientable groups, which can be reoriented upon illumination with light at a wave-length and for a time period that initiates the reorientation, which can self-develop at a suitable temperature, typically above the glass transition temperature (Tg).

These and other aspects of the invention will be apparent from the embodiments(s) described hereinafter.

The present invention will also be more clearly understood from the following description of the preferred embodiments of the invention read in conjunction with the attached drawings, in which:

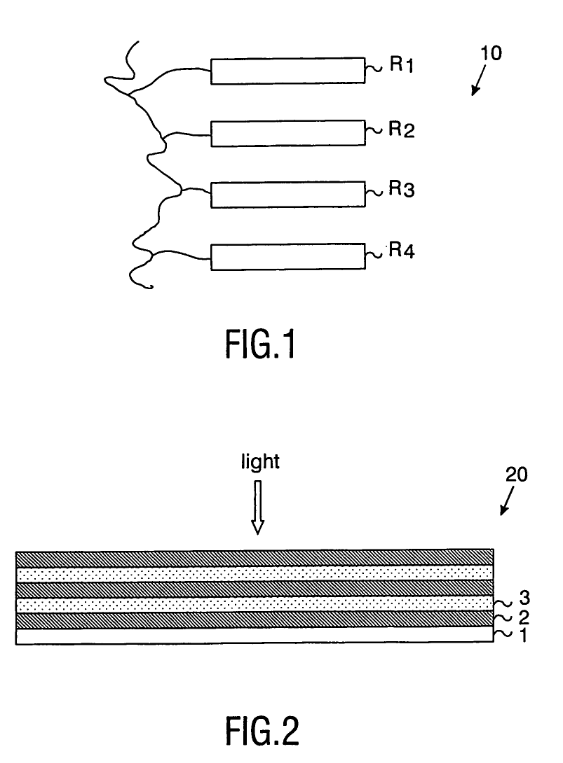

FIG. 1 illustrates a multi-functional polymer according to a preferred embodiment of the invention.

FIG. 2 illustrates a device for storing data having stacked storage layers.

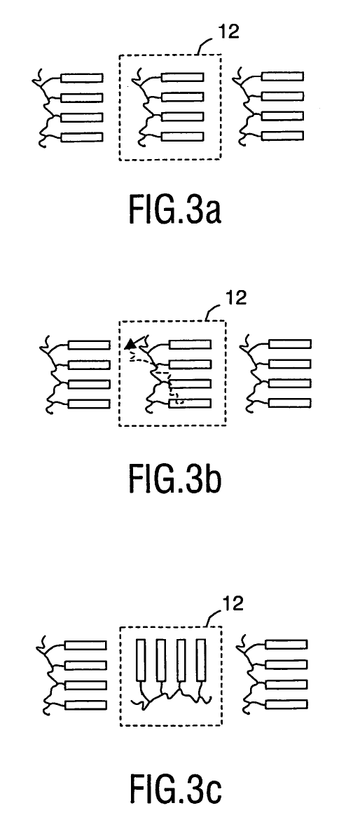

FIG. 3 illustrates how the polymer of FIG. 1 is converted from a non-written state to a written state.

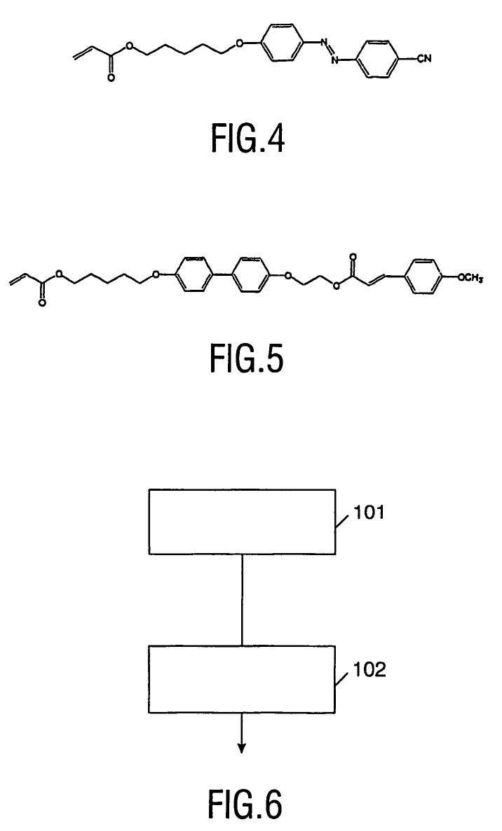

FIG. 4 illustrates an azo-benzene group.

FIG. 5 illustrates a cinnamate group.

FIG. 6 is a flow-chart illustrating a preferred embodiment of the method according to the invention.

The invention will now be described starting with reference to FIG. 1 illustrating a multifunctional polymer according to a preferred embodiment of the invention.

The different properties that are required to store information are combined in the multi-functional polymer as illustrated in FIG. 1. The polymer 10 comprises three or more different functional groups. The first group R₁, has liquid crystallinity, the second group R₂ is a photo-orientable group and the third group R₃ contains a fluorescent chromophore. Optionally a fourth group R₄ can comprise an additional functionality, e. g. to tune the glass transition temperature T_{g} of the polymer. In this way, it is possible to optimise and fine-tune different functions independently from each other because the functions are separated into different groups. Of course, more functional groups can be added if required, without departing from the inventive idea.

It is also possible to use a polymer with less then three groups if different functionalities are combined in one group, e.g. a fluorescent moiety and a mesogenic group can be combined in a fluorescent liquid crystalline group. Other combinations are also possible.

Preferably, the polymer is provided with groups that provide the high stability of anisotropic polymers for data storage, but at the same time avoid problems with slow switching. The storage is based on a photo-induced change in suitable molecular groups, which can be provided into the main chain of the polymer or in side-groups. The polymer described in FIG. 1 is only an example of a polymer with functional groups provided in the side-groups thereof, and other configurations that fulfill the requirements can also be employed.

The first group R₁ having liquid crystallinity can be provided in an essentially known manner, which will therefore not be described in more detail. As an example, the first group R₁ comprises repetitive units, including spacer units, and groups providing liquid crystal character such as mesogenic groups.

The second group R₂ comprises photosensitive units, which are capable of isomerization. The photosensitive units are typically provided in side-groups, but may also be present in the backbone of the group R₂, or in both. Usually these photosensitive groups are based on one or more of the general formula
R-PH
where PH is a photosensitive group, preferably selected from the group comprising azobenzene, biazobenzene, triazobenzene and azoxybenzene, as well as alkyl substituted derivatives of the same, stilbene or spiropyran groups, and where R stands for a group which enables the chemical bonding of the photochemical unit into the polymer 10, typically a group that is capable of polymerisation or polycondensation.

For instance azo-benzene groups are rewritable. Upon irradiation with light of an appropriate wavelength, the azo-benzene units will undergo a reversible cis-trans isomerization around the nitrogen-nitrogen double bond. In this process, there is a driving force for the azo-benzene units to decrease the absorption cross section and orient their absorption dipole moment along the propagation direction of the light. FIG. 4 illustrates an azo-benzene group.

It is also possible to use other groups than cis-trans isomers, that reversibly can change molecular order by irradiation with light, of which particular examples will not be discussed herein, since they are obvious for a person skilled in the art.

It is also possible to provide irreversible writing by means of for instance cinnamate groups. Such a group undergoes upon irradiation with light of suitable wavelength a photo-addition reaction, which results in an orientation perpendicular to an E-vector of the light. Since this reaction is not reversible, the writing can be considered as an example of WORM writing. FIG. 5 illustrates a cinnamate group.

Already, there is a great demand for WORM optical data storage disks, so-called “CD-R” and it is expected that this demand will increase when the storage capacity of the optical data disks increases. When using a WORM medium for content distribution, the writing process could be serial (data bits are written one after the other); however, it is not economically interesting to incorporate serial writing processes in the manufacturing process of cheap optical data storage media. Data replication during manufacturing is typically only worthwhile when it can be done in a parallel writing process, e.g via a stamper or a mould. This is one of the essential advantages of optical storage over other storage options such as hard disk and solid state memories. Therefore, in a ROM medium, it is preferred to use some type of parallel writing, even if this is not disclosed herein.

The third group R₃ comprising a fluorescent chromophore will change its absorption cross section when rotated, whereby rotation (typically 90°) of an anisotropic molecule (a dipole) gives a contrast in absorption (compared to a reference) and thus in fluorescence when irradiated. This change of absorption cross section is also valid for the second group R₂ and in some cases, depending on group, also for the first group R₁. The variation of molecular geometry and the induced local non-equilibrium states causes variations in the optical properties such as refractive index, double refraction or absorption properties, of which the latter will be described herein when a device for storing data and the storing principle thereof are further described below.

In FIG. 2, a device 20 for storing data having stacked storage layers is illustrated in cross section in a direction perpendicular to a plan surface of the stacked layers. A base plate 1 is covered with a polymer layer 2. The base plate 1 is typically several cm² in surface area and may have an insulation layer such as an InO₂/SnO₂ layer deposited thereon. The polymer layer 2 can for instance be spin-coated or applied in another suitable way, and the thickness of the polymer layer can typically be from 10⁻³ to 10⁻⁶ m. In some cases, it may be necessary to be careful, when using very thin films or particular concentrations, that optical features are not significantly altered. However, such problems will not be further discussed herein, since they are obvious for a person skilled in the art.

The polymer layer 2 is covered with a separation layer 3, whereby this combination, i.e. the polymer layer 2 and the separation layer 3 can be stacked several times, in this particular embodiment illustrating three polymer layers. However, multiple polymer layers 2, typically more than ten can be provided. Alternatively, the polymer can be provided as laminate with other suitable materials, or as a coating on a matrix layer, even if these examples are not illustrated in this figure.

When writing into one polymer layer, a first laser beam coming from a light source (illustrated by an arrow labelled “light”) is focussed on a certain area in the data storage medium, whereby the polymer in this area reorients due to the photo-orientable groups, which will be further disclosed below. The first laser beam, for instance having blue light, initiates the reorientation, whereby a second beam (from the same source) of an intensity high enough to heat the polymer above its glass-transition temperature Tg, finishes the reorientation. The resulting written area can then be read as optical data.

The optical data storage device 20 can for instance be in the form of an optical disk, whereby data, typically in the form of bits, are read onto circular tracks by means of a probing laser beam when this disk rotates in an optical record player or an optical card. Another possibility could be to provide holographic storage, whereby a hologram of an image is recorded as an interference pattern. These, and other applications will not be described in more detail, since such technologies are well known within this technical field.

Now is referred to FIG. 3a-c, illustrating how the polymer is converted from a non-written condition to a written condition. The polymers, of which three are shown, are illustrated in direction perpendicular to the cross-section in FIG. 2, i. e. in the same direction as the arrow denoted “light”. FIG. 3a shows a situation after alignment, but before initiation. FIG. 3b shows initiation of a central area 12 (the local focal area) of part of the polymer layer, herein the centre polymer, indicated by an arrow in the left corner thereof. FIG. 3c shows part of the polymer layer after being written. The central area 12 now comprises the groups in a direction, which is essentially perpendicular to the direction after alignment. This direction is only intended to illustrate the principle of the invention, and is therefore not limited to this particular direction.

The initial orientation of the multi-functional polymers in FIG. 3a can be achieved for instance by means of surface effects such as shearing or drawing, or by means of an additional layer, a so-called “alignment layer” (not shown) provided thereon, or by means of field effects such as an alignment field, particularly a magnetic field or an electrical field. If the groups are aligned by means of an electrical field, transparent electrodes can be provided surrounding the polymer layers from two sides.

However, the electrodes do not have to be incorporated in the device. During manufacturing it is possible to apply an electric field even when the electrodes are not incorporated in the medium. For a WORM application, typically electrodes neither are required nor desired. For a (limited) RW application it is also possible to envision only two general electrodes that sandwich all storage layers to provide a general re-orientation capability for the whole device. If electrodes sandwich every layer, a more local erasure and initial material orientation per layer is possible. In principle, even an user-drive could be made to provide the external global alignment field so that an RW medium without internal electrodes is achieved. Because of the high voltages required in this case (The voltages increase linearly with the separation of the electrodes), this might not be the most practical solution, even if it is possible.

It is also possible to combine an alignment layer and an alignment field. The alignment layer could for instance force a homeotropic alignment of the functional groups in the polymer. The aligning force of the alignment layer can be overruled by the force of an alignment field during deposition of the data layer. In this way a planar alignment is obtained. Now, during the writing process, the force exerted by the photo-orientable units and the force of the alignment layer will co-operate to cause a reorientation of all functional groups. In this way, the writing speed can be enhanced. In the normal case where the alignment layer causes planar alignment, the forces exerted by the alignment layer and the photo-orientable units oppose each other during the writing process, limiting the writing speed.

The first laser beam that initiates the reorientation as illustrated in FIG. 3b moves on, while the initiated polymer material self-develops during a longer time period than the initiation took to end up in its final orientation as illustrated in FIG. 3c. The time-period that is required is determined by the type of polymer, which of course has to be properly chosen to fulfill the requirements regarding switching-time. A typical example can be something like a first laser beam within nanoseconds and a second heating beam for a few milliseconds, a particular example can be approximately 6 ns and 3 ms. This time period is determined by reorientation of the other groups than the photo-orientable group since the driving force for the other groups is relatively small (elastic energy), i. e. latter switch faster. It is also possible that heating and photo-reorientation is both done with a short laser pulse and that the material stays above Tg for several milliseconds as a result of the poor heat conductivity of the medium, allowing for the self-development. It is also possible that a short laser pulse is used to heat the sample above Tg (where it will stay for milliseconds (ms)) and a second irradiation over a longer time period is used for the photo-reorientation.

The laser beams can for instance come from a diode laser, typically with a wavelength of approximately 400 nm. However, there is a great flexibility in the choice of wavelengths, both for writing and reading. For instance dyes can be added to provide sensitivity at a suitable wavelength. Both the writing beam and the heating beam can according to a preferred embodiment of the invention, be combined into one beam (as illustrated in FIG. 2) that both initiates and heats, or alternatively be spatially separated everywhere except at the desired writing position to increase non-linearity of the method.

The method for writing data according to a general preferred embodiment of the invention can be illustrated with reference to FIG. 6, which is a flow-chart of the same. In a first step 101, the polymer material is heated above its glass transition temperature Tg, and in a second step 102, writing is initiated by orientation of photo-orientable groups of the polymer by means of illuminating with light that initiates the reorientation.

Reading of information can be performed for instance by irradiating the polymer layers with monochromatic coherent light, typically laser light to read data by means of using the change in orientation of anisotropic fluorescent dye molecules, i. e. the third group R₃. Typically, the different orientation of the transition dipole moments of the fluorescent chromophores in “written” and “non-written” areas causes a contrast in absorption and thus in fluorescence. The contrast can typically be about 1:7. Of course, also other anisotropic groups that change orientation can be employed, for instance the photo-orientable group. Also other types of groups than anisotropic, that change optical properties when illuminated with light from an intense writing beam, which properties can be read by a weaker reading beam could be possible, provided that initiation is fast enough. It is also possible to provide the optical properties in a blend, rather than in the polymer itself, or to use additives.

Erasing the stored information can be obtained by increasing the temperature above the glass-transition temperature Tg and cooling in an electrical or magnetic field. It can also be obtained by re-alignment to the alignment layer when above the Tg or by a reversed photo-orientation process

The glass-transition temperature Tg typically is above ambient temperature. However, it is preferred to have control over the glass transition temperature in order to be sure that the stored data will not be degraded during storage at desired temperatures. Such methods, for instance to use vinyl based polymers, are well known and will therefore not be further described herein.

The time scale on which the laser pulse has to be applied is much shorter than the time-scale on which the anisotropic molecules reorient. Thereby, high recording data rates can be combined with a high recording stability.

The solution for data recording, which can be applied in multi-layer optical data storage media, has several advantages over prior art. These advantages are the following: increased stability of stored information, fast writing speed possible, independent optimisation of material properties possible, increased fluorescent signal intensity through anisotropic emission (factor two to three in photons) and increased absorption cross section (enabling thinner layers for a given, optimal absorption).

Since also the invention provides a small difference in the index of refraction of written and non-written bits, this will result in reduction of beam quality as the light transverses the different layers, even if it is small compared to conventional techniques. In a stacked device having many polymer layers, say above ten, the differences between written and non-written bits can be further reduced by careful choice of materials, i. e. typically by selecting a fourth compensating group. Alternatively, this difference could instead be increased to be used by sensing this as an optical parameter, for instance by means of a differential phase contrast microscope set-up in transmission.

Even if only reading by means of using fluorescence is described in the examples, any other method capable of sensing optical parameters dependent on molecular orientation can be employed.

The device for optical data storage can also be used e.g. for optical signal processing, Fourier transform, and other recording purposes than described.

As used in the following claims, the word “comprise” means including, but not necessarily limited to.

1. A method for writing data in a storage medium comprising polymer material by modifying its optical properties, said method comprising the steps of:
heating up the material above the glass-transition temperature (Tg), and
initiating the writing by reorientation of photo-orientable-groups in the polymer material by means of illuminating with light at a wavelength and for a time period, or other means, that initiates the reorientation.

2. A method according to claim 1, wherein the photo-orientable groups are one or more anistropic groups present in the polymer material.

3. A method according to claim 1, wherein initiating and heating are performed by means of a single beam.

4. A method according to claim 1, wherein initiating is performed by means of a first beam and heating is achieved with a second beam.

5. A method according to claim 1, wherein initiating is performed during a time period which is much shorter than a time scale on which the polymer, preferably an LC polymer, reorients, typically a time period within a nanosecond time regime such as 10-50 ns.

6. Device for optical data storage, comprising:
polymer material as storage medium,
means for heating up the material above the glass-transition temperature (Tg), and
means for initiating the writing by reorientation of photo-orientable-units of the polymer by illuminating with light at a wave-length and for a time period, or other means, that initiates the reorientation, whereby data can be stored in the polymer material by modifying its optical properties

7. Device according to claim 6, wherein the polymer material comprises one or more anisotropic polymers.

8. Device according to claim 6, wherein a polymer layer, preferably a polymer film, is provided on a transparent base plate.

9. Device according to claim 6, wherein said device comprises combined heat source means and light source means, whereby said polymer film may be heated and the molecular order or orientation of said film may be varied.

10. Device according to claim 6, wherein said device comprises physical orientation means such as an alignment layer, and/or transparent electrode means for orientation of the polymer layers before writing.

11. Device according to claim 6, wherein said heating source means and/or light source means comprises a laser.

12. Device according to claim 6, wherein absorption properties of said polymer film provide data to be stored with a laser beam of a particular wavelength and intensity and read out with another laser beam having a different wavelength, or different intensity significantly below the writing threshold, not disturbing the stored data.

13. Storage medium comprising polymer material, adapted to store data by modifying its optical properties, said polymer material comprising photo-orientable groups (R₁-R₄), which can be reoriented upon illumination with light at a wave-length and for a time period that initiates the reorientation, which can self-develop at a suitable temperature, typically above the glass transition temperature (Tg).

14. Storage medium according to claim 13, comprising groups selected from: azobenzene, biazobenzene, triazobenzene and azoxybenzene, as well as alkyl substituted derivatives of the same, stilbene or spiropyran groups.
